(19) United States
(12) Patent Application Publication
(10) Pub. No.: US 2022/0035967 A1
(43) Pub. Date: Feb. 3, 2022

(54) EFFICIENT METHOD FOR REPRESENTATION AND OPTIMIZATION OF POROUS STRUCTURES

(71) Applicant: DALIAN UNIVERSITY OF TECHNOLOGY, Dalian (CN)

(72) Inventors: Shengfa WANG, Dalian (CN); Jiangbei HU, Dalian (CN); Xiaopeng ZHENG, Dalian (CN); Na LEI, Dalian (CN); Zhongxuan LUO, Dalian (CN)

(21) Appl. No.: 17/349,270

(22) Filed: Jun. 16, 2021

(30) Foreign Application Priority Data
Jul. 28, 2020 (CN) 202010734576.6

(51) Int. Cl. G06F 30/20

(52) U.S. Cl. CPC G06F 30/20; G06F 2111/10

(57) ABSTRACT

An efficient method for representation and optimization of porous structures belongs to the field of computer aided design. Firstly, a representation method of a multi-scale porous structure described by a function is provided. Based on the function representation, an optimization frame is designed. Then, an optimization problem model is established by taking structural energy minimization as a goal and taking a volume and a gradient as constraints. Finally, topological optimization is conducted firstly, and then geometric optimization is conducted. The topology and the thickness of the porous structure are optimized to obtain an optimization model filled with the porous structure. The present invention completely represents, analyzes, optimizes and stores the porous structure by functions, which greatly reduces the calculation complexity and greatly shortens the design and optimization period. Moreover, the present invention can provide an optimization model with strong structural hardness and stiffness under the volume constraint. The structure is suitable for frequently-used 3D printing manufacturing technologies. The internal structure does not need additional support in the printing process, which can save printing time and printing material.

### TECHNICAL FIELD

The present invention relates to the field of computer aided design, and mainly relates to a representation and optimization method of porous structures based on a triply periodic minimal surface (TPMS), which can be applied to the fields of medical, biological and engineering design.

### BACKGROUND

Manufacturing of structures with light weight and strong mechanical properties has become an important topic in the fields of industry and biology, and has great challenges and opportunities for development. The widely used porous structure has been largely researched. The proposed hollow structure, frame structure and honeycomb structure have made certain contributions to lightweight work. However, the traditional porous structures have more or less corresponding problems. For example, the honeycomb structure and the frame structure generate stress concentration and must be subjected to force analysis by the traditional FEM method in the process of optimization design, thereby consuming time and bringing great cost to production and application. Recently, porous bracket structures based on TPMS have attracted the attention of many researchers and engineers and have been researched and applied in many fields. Such structures have many advantages such as internal connectivity, high area-to-volume ratio and high strength and stiffness. In addition, one of the most important advantages is that the porous structures based on TPMS can be generated by functions so that it is easy to control the types of hollow holes and the thickness of the structures, to bring convenience for efficient optimization design under set objectives and constraints. Moreover, such structures are suitable for frequently-used 3D printing technologies (SLA, SLS, SLM, FDM and the like).

However, the existing optimization technologies for such porous structures are heuristic or experimental. No mature technology has been applied to optimize pores using the period of the TPMS. Period-based pore optimization cannot be directly applied to the traditional topological optimization methods (such as SIMP method, level set method and MMC method).

The present invention proposes an efficient and automatic porous structure optimization frame based on TPMS, which fills pores in a model so as to realize continuous change along with topology and thickness corresponding to mechanical properties. The present invention mainly uses the advantage of function representation of TPMS to design a multi-scale porous bracket structure which can be represented, analyzed, optimized and stored by functions completely, so that the calculation complexity is greatly reduced and the whole optimization process is efficient and robust.

### SUMMARY

The present invention proposes an efficient method for generating porous structures and establishes a complete set of automatically optimized and efficient multi-scale porous structure design and optimization frame. In step 1, a function is used to describe the generation method of a porous structure based on the TPMS; In step 2, an external boundary condition is provided by taking an actual stress condition as a reference, and then an optimization problem model is established by taking energy minimization as a goal and taking a volume and a gradient as constraints to propose corresponding topological optimization and geometric optimization models.

Finally, the problem model is discretized; the problem is solved by an efficient solution optimization algorithm; optimized parameter values are obtained; and an optimized multi-scale porous structure under given constraints is further designed. A whole design process is shown in FIG. 1.

The present invention adopts the following technical solution:

An efficient method for representation and optimization of porous structures is as follows:

(I) Modeling of a Porous Shell Structure

1. Representation of the Multi-Scale Porous Shell Structure

Firstly, frequently-used TPMSs are P-surface, G-surface and D-surface respectively, and have implicit function representation forms as follows:

φ_{P}(r)=cos(2π·x)+cos(2π·y)+cos(2π·z)=c

φG(r)=sin(2π·x)cos(2π·y)+sin(2π·z)cos(2π·x)+sin(2π·y)cos(2π·z)=c (1)

φ_{D}(r)=cos(2π·x)cos(2π·y)cos(2π·z)−sin(2π·x)sin(2π·y)sin(2π·z)=c.

wherein r=(x, y, z)∈R³ and c are values of isosurfaces. The TPMS has many advantages. Firstly, as a minimal surface, the TPMS has good smoothness. Secondly, the TPMS is completely connected in the inner space without a closed cavity. Thirdly, the TPMS has a high area-volume ratio, which has high use value in the field of medicine. Additionally, more importantly, the TPMS has good mechanical properties and high strength and stiffness so that the TPMS is also widely used in the industrial field.

Based on the description of the TPMS and according to the feature of implicit function isosurfaces, the porous shell structure with thickness is further constructed. It is easy to know that two surfaces defined by φ(r)=_{c} and φ(r)=c will never intersect when c₁≠c₂. According to this characteristic, the closed inner space of the two surfaces is defined as the porous shell structure, so that the thickness of the structure can be controlled by controlling the values of the isosurfaces. A specific definition mode is as follows:

ϕ^{s}(r)=min(ϕ₁(r),ϕ₂(r))

ϕ₁(r)=φ(r)+c(r) (2)

ϕ₂(r)=c(r)−φ(r)

wherein t(r) is a continuous geometric function (parameter) used to control the thickness of the shell structure, and c(r) is used to represent any TPMS. Finally, ϕ^{s}(r)>0 represents a region defined as Ωₛ, i.e., an interior of the porous shell structure based on the TPMS.

To construct the multi-scale porous structure, a topological function is introduced into (2) to control the topology of the structure, with the P-surface as an example:

\tilde{φ}_{P}(r)=cos(2π·t(r)·x)+cos(2π·t(r)·y)+cos(2π·t(r)·z) (3)

wherein t(r)>0 is a continuous topological function (parameter) used to control the period of the TPMS, so as to control the pore size of the porous structure.

A model M is given to fill the porous structure based on the TPMS in the model as follows:

ϕ^{M}=ϕ^{s}∩ϕ^{VDF}=min(ϕ^{s},ϕ^{VDF}) (4)

wherein ϕ^{VDF} is a distance field of the model M; and ϕ^{M}≥0 represents the interior of the model filled with the porous structure.

2. Parameter Discussion

According to the study of the porous structure based on the TPMS, it is found that: 1) for the fixed topology (i.e., the period of the porous structure), the strength of the structure is increased with the increase of the thickness; and 2) for the fixed geometry (i.e., the thickness of the porous structure), the strength of the structure is increased with the increase of the period value. In the present invention, the topology is controlled by the topological parameter t(r) and the thickness is controlled by the geometric parameter c(r).

Geometric parameter: according to the experimental data, when c₁≠c₂, the porous structure can avoid self-intersection both locally and globally and can produce an effective bracket structure. In addition, the minimum thickness must not be less than the minimum printing accuracy. Therefore, according to experimental research and mathematical reasoning, the linear relationship among the geometric parameter, the topological parameter and the thickness is obtained. The value range of c(r) is set as

$$[ \frac{{ω}_{min} {t}_{0}}{0.1838} , 0.8 ] ,$$

wherein ωₘᵢₙ is the default value of the minimum printing accuracy, and the default to t₀=1 is an initial topological parameter.

Topological parameter: in the optimization process,

$${c}_{0} = ( \frac{{ω}_{min} {t}_{0}}{0.1838} + 0.8 ) / 2$$

is given, and then the value range of the topological parameter should be

$$t ( r ) ∈ ( 0 , \frac{0.8 {t}_{0}}{{c}_{0}} ) ,$$

wherein default to =1 is an initial topological parameter.

In the design of the porous structure, the topological parameter t(r) also influences the thickness of the structure. To avoid the influence of homogenization in the process of adjustment and optimization of t(r), the thickness of the shell structure should be unchanged (not only c(r) is unchanged). According to the linear relationship among the geometric parameter, the topological parameter and the thickness, in the process of topological optimization, (2) should be modified to design the porous structure as follows:

$${ϕ}_{1} ( r ) = \tilde{φ} ( r ) + \tilde{c} ( r ) \\ {ϕ}_{2} ( r ) = \tilde{c} ( r ) - \tilde{φ} ( r ) \\ \tilde{c} ( r ) = {c}_{0} ( r ) \frac{t ( r )}{{t}_{0} ( r )} \qquad ( 5 )$$

wherein \tilde{c}(r) is the modified geometric parameter used to eliminate the influence of the topological parameter on the thickness in the adjustment process, so as to ensure that the thickness is always unchanged in the process of topological optimization.

(II) Optimization Modeling and Solution of the Porous Shell Structure

The purpose of the present invention is to use the porous structure represented by the above function method to fill the interior of the given model, so as to achieve the purpose of light weight. The optimal pore size distribution and shell structure thickness distribution which ensure minimum structural energy are obtained under the given material volume constraint and pore size change gradient constraint after model stress and boundary conditions are provided.

### 1. Construction of Optimization Model

filling the inner space of the model using the constructed multi-scale porous shell structure by taking structural energy minimization as a goal and taking a model volume and a pore size distribution gradient as constraints, so that the strength and stiffness of the model are still strong under the condition of given material volume constraints; calculating by a finite element analysis method so that the problem needs to be discretized; increasing calculation efficiency while ensuring calculation accuracy by a super element method; uniformly dividing a design domain into super elements firstly and then uniformly subdividing the super elements into background elements; interpolating the displacement field by a super element mesh system; and describing the model by a background element system and conducting integral calculation.

Finally, constructing a problem model according to the above purpose as follows:

$${min}_{c ( r ) , t ( r )} I = {F}^{T} U \qquad ( 6 )$$

so that

$$KU = F \\ V = \frac{1}{8} {\sum }_{j = 1}^{{N}_{b}} {\sum }_{l = 1}^{8} {H}_{η} ( {ϕ}_{l}^{j} ) {v}_{b} \leq \overline{V} \\ G = \frac{1}{‖ {Ω}_{M} ‖} {\sum }_{j = 1}^{{N}_{b}} {\sum }_{l = 1}^{8} ℏ ( \frac{‖ ∇ {t}_{l} ‖}{\overline{g}} ) {v}_{b} \leq 1 \qquad ( 7 )$$

wherein I is structural energy of the model; U is a displacement vector; F is a force vector of a node point; K is a total stiffness matrix; V is a volume fraction; V̅ is a designated volume constraint; ϕₗ^{j} is a value of ϕ^{s} at the l node point of the j background element; G is a gradient of the periodic distribution; g̅ is a designated gradient constraint value; v_{b} is the volume of the background elements; N_{b} is the number of the total background elements in a solution domain; ∥∇tₗ∥ is a value of the periodic distribution gradient ∥∇t(r)∥ at the l node point of the j background element; and ∥Ω₁₁∥ is the volume of the design domain; and H_{η}(x) is a regularization Heaviside function:

$${H}_{η} ( x ) = \{ \begin{matrix}1 , & if x > η , \\ \frac{3 ( 1 - α )}{4} ( \frac{x}{η} - \frac{{x}^{3}}{3 {η}^{3}} ) + \frac{( 1 + α )}{2} , & if - η \leq x \leq η , \\ α , & if x < - η ,\end{matrix} \qquad ( 8 )$$

wherein η is used to control the degree of regularization, and the value selection is related to the degree of meshing. a>0 is a small positive number used to ensure the nonsingularity of a global stiffness matrix. h(x) is defined as follows:

$$ℏ ( x ) = \{ \begin{matrix}{( x - 1 )}^{2} + 1 , & if x \geq 1 \\ 1 , & if x < 1\end{matrix} \qquad ( 9 )$$

### 2. Optimization Process

For the above constructed optimization problem, only two unknown parameters t(r) and c(r) need to be calculated and optimized. Topological optimization is regarded as rough optimization; after the topology of the whole porous structure is determined, more detailed optimization, i.e., geometric optimization, is conducted; therefore, at fixed thickness, t(r) is optimized firstly, then a topological parameter is fixed, and c(r) is optimized. A specific optimization process is as follows:

Step 1: topological optimization: interpolating the topological parameter t(r) by a radial basis function (RBF) interpolation method and converting function optimization into the optimization of the parameter at an interpolation node point; randomly selecting an interpolation point {pᵢ}ᵢ₌₁ⁿ^{ᵣ}∈Q in the design domain Ω_{M}, so that the form of interpolation t(r) is:

$$t ( r ) = {\sum }_{i = 1}^{{n}_{r}} R ( r ) {a}_{i}^{t} + {\sum }_{j = 1}^{m} {q}_{j} ( r ) {b}_{j}^{t} \qquad ( 10 )$$

wherein Rᵢ(r)=R(∥r−pᵢ∥); logarithmic RBF R(x)=x² log(|x|) is selected; {qⱼ(r)} is a polynomial for coordinates; and aᵢ^{t} and bⱼ^{t} are undetermined coefficients. Through derivation, (10) can be simplified as:

$$t ) r\_ = {\sum }_{i = 1}^{{n}_{r}} {S}_{i} ( r ) {t}_{i} \qquad ( 1 )$$

wherein tᵢ=t(pᵢ) is a periodic value at a control point pᵢ; Sᵢ(r) is a polynomial form derived from matritization; thus, the optimization of a topological structure is converted into the optimization of the parameter {tᵢ}ᵢ₌₁ⁿ^{ᵣ};

finally, calculating the derivatives of an objective function and a constraint function for optimization variables to obtain the sensitivity information of the variables as follows:

$$\frac{\partial I}{\partial t} = - {\sum }_{k = 1}^{{N}_{s}} {U}_{k}^{T} ( \frac{1}{8} {{\sum }^{{N}_{b}}}_{j = 1} ( {\sum }_{l = 1}^{8} \frac{\partial {H}_{η} ( {ϕ}_{l}^{kj} )}{\partial {t}_{i}} ) {K}^{0} ) {U}_{k} \\ \frac{\partial V}{\partial t} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b} \\ \frac{\partial G}{\partial t} = \frac{1}{‖ {Ω}_{M} ‖} {\sum }_{j = 1}^{{N}_{b}} {\sum }_{l = 1}^{8} ℏ ( \frac{‖ ∇ {t}_{l} ‖}{\overline{g}} ) \frac{\partial ‖ ∇ t ‖}{\partial {t}_{i}} {v}_{b} \qquad ( 12 )$$

wherein Nₛ is the number of the super elements; N_{b} is the number of the total background elements in the design domain; Uₖ is a node point displacement vector corresponding to the k element; K⁰=E₀B^{T}D⁰Bv_{b}; E₀ is Young's modulus; B is a strain matrix; D⁰ is a constitutive matrix of solid material filled by the elements; ϕₗ^{ij} is a value of ϕ^{s} at the l node point of the j background element in the i super element; then, sensitivity information is substituted into a solution optimization algorithm MMA which is commonly used in the field of mechanics to obtain the solution of the problem under topological optimization, i.e., the value of an optimal parameter {tᵢ}ᵢ₌₁ⁿ^{ᵣ}; in this way, the topological form of the porous structure is determined.

Step 2: geometric optimization: geometric optimization is the optimization of the parameter c(r); converting the function optimization into the optimization of the parameter {cᵢ}ᵢ₌₁ⁿ^{ᵣ} at the control point using the same technology as topological optimization by the RBF; randomly selecting an interpolation point {pᵢ}ᵢ₌₁ⁿ^{ᵣ}∈Ω_{M} in the design domain Ω_{M}, so that the form of interpolation c(r) is:

$$c ( r ) = {\sum }_{i = 1}^{{n}_{r}} {R}_{i} ( r ) {a}_{i}^{c} + {\sum }_{J = 1}^{m} {q}_{j} ( r ) {b}_{j}^{c} \qquad ( 13 )$$

wherein aᵢ^{c} and bⱼ^{c} are undetermined coefficients, which can also be simplified as:

$$c ( r ) = {\sum }_{i = 1}^{{n}_{r}} {S}_{i} ( r ) {c}_{i} \qquad ( 14 )$$

wherein cᵢ=c(pᵢ) is a thickness value at the control point pᵢ; Sᵢ(r) is a polynomial form derived from matritization; then, the sensitivity information about the optimization variables can be calculated and substituted into the MMA to obtain the solution of the problem under geometric optimization.

$$\frac{\partial l}{\partial {c}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {c}_{i}} ) {K}^{0} ) {U}_{k} \\ \frac{\partial V}{\partial {c}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {c}_{i}} {v}_{b} \qquad ( 15 )$$

In this way, after topological optimization, controlling the thickness more precisely to minimize the structural energy, thereby having high hardness and strength.
The present invention belongs to a modeling and optimization system in the field of computer aided design, and designs and manufactures the internal porous filling structure of the model for the needs of 3D printing and industrial production. The present invention proposes a new efficient algorithm for representation domain optimization of the porous structure. This structure can be described, analyzed, optimized and stored completely by functions. In the design and optimization problems of the porous structure based on the TPMS, the present invention has low calculation complexity and high efficiency, greatly shortens the design and optimization period of the porous structure, and can meet the requirements of industrial production to provide an optimal result. Moreover, the porous structure based on the TPMS has many advantages such as smoothness (facilitating force and heat transfer in industry, and cell adhesion in biology), full communication (capable of exporting the waste generated by printing in the process of 3D printing and facilitating cell migration in biology), easy control (capable of arbitrarily changing the shape of the structure by controlling the parameters of the function), quasi-self-supporting (saving material), and the like. These properties allow this structure to have great applicability and development space in the fields of industry and biology.

### DESCRIPTION OF DRAWINGS

FIG. 1 is a flow chart of representation and optimization of a porous shell structure.

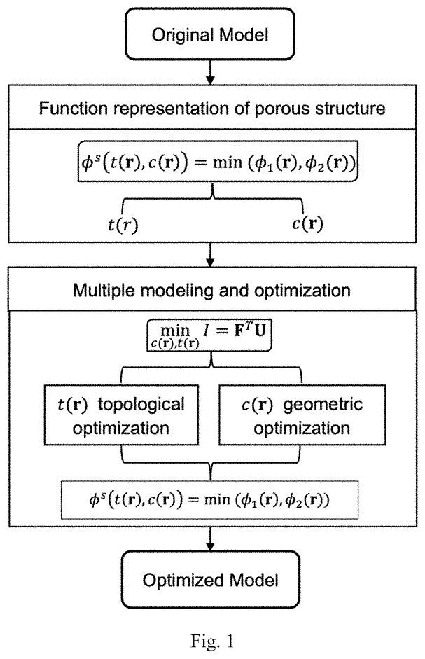

FIG. 2 is a diagram of optimization results and printing model of a porous shell structure based on P-surface.

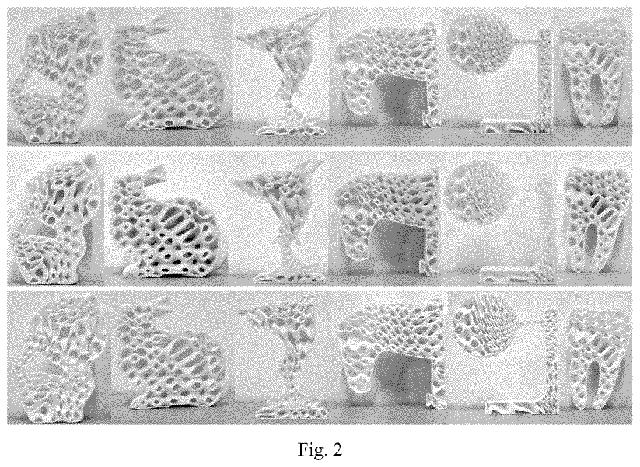

### DETAILED DESCRIPTION

The implementation of the present invention can be specifically divided into the main steps of function presentation of the multi-scale porous shell structure, establishment of an optimization model and discretization, and optimization solution:

### (I) Multi-Scale Porous Shell Structure

The P-surface is taken as an example to illustrate how to represent the multi-scale porous shell structure by a function. Firstly, establishing a multi-scale porous surface:

\tilde{φ}_{P}(r)=cos(2π·t(r)·x)+cos(2π·t(r)·y)+cos(2π·t(r)·z)

wherein t(r)>0 is a continuous periodic distribution function, which controls the continuous change of a pore size;

then, constructing a multi-scale porous shell structure with thickness: using a closed region determined by two different isosurfaces with the same periodic distribution as an inner space of a porous shell, i.e., defining:

$${ϕ}^{s} ( r ) = min ( {ϕ}_{1} ( r ) , {ϕ}_{2} ( r ) )$$

$${ϕ}_{1} ( r ) = \tilde{φ} ( r ) + \tilde{c} ( r )$$

$${ϕ}_{2} ( r ) = \tilde{c} ( r ) - \tilde{φ} ( r )$$

$$\tilde{c} ( r ) = {c}_{0} ( r ) \frac{t ( r )}{{t}_{0} ( r )}$$

wherein ϕ^{s}(r)>0 represents a region defined as Ωₛ, i.e., an interior of the porous shell structure based on a TPMS;
for a given model M, optionally, representing a model filled with the porous structure by a function:

ϕ^{M}=ϕ^{s}∩ϕ^{VDF}=min(ϕ^{s},ϕ^{VDF})

then ϕ^{M}≥0 represents the interior of the model filled with the porous structure.

In the above function description, c(r) controls the thickness of the porous structure; the value range is

$$[ \frac{{ω}_{min} {t}_{0}}{0.1838} , 0.8 ] ,$$

wherein ωₘᵢₙ is a default value of minimum printing accuracy; t(r) controls the pore size distribution of the porous structure; the value range is

$$t ( r ) ∈ ( 0 , \frac{0.8 {t}_{0}}{{c}_{0}} ) ,$$

wherein to t₀=1 is a default initial topological parameter,

$${c}_{0} = ( \frac{{ω}_{min} {t}_{0}}{0.1838} + 0.8 ) / 2 .$$

### (II) Establishing an Optimization Model and Discretization Thereof

filling the inner space of the model using the constructed multi-scale porous shell structure by taking structural energy minimization as a goal and taking a model volume and a pore size distribution gradient as constraints, so that the strength and stiffness of the model are still strong under the condition of given material volume constraints; calculating by a finite element analysis method so that the above problem needs to be discretized; increasing calculation efficiency while ensuring calculation accuracy by a super element method; uniformly dividing a design domain into super elements firstly and then uniformly subdividing the super elements into background elements; interpolating the displacement field by a super element mesh system; and describing the model by a background element system and conducting integral calculation.

Calculating all local element stiffness matrices as above, and then integrating the matrices into a global stiffness matrix K to obtain a discrete form of the optimization problem:

$${min}_{c ( r ) , t ( r )} I = {F}^{T} U$$

so that

$$KU = F$$

$$V = \frac{1}{8} {\sum }_{j = 1}^{{N}_{b}} {\sum }_{l = 1}^{8} {H}_{η} ( {ϕ}_{l}^{j} ) {v}_{b} \leq \overline{V} \\ G = \frac{1}{‖ {Ω}_{M} ‖} {\sum }_{j = 1}^{{N}_{b}} {\sum }_{l = 1}^{8} ℏ ( \frac{‖ ∇ {t}_{l} ‖}{\overline{g}} ) {v}_{b} \leq 1$$

wherein I is structural energy of the model; U is a displacement vector; F is a force vector of a node point; K is a total stiffness matrix; V is a volume fraction; V̅ is a designated volume constraint; ϕₗ^{j} is a value of ϕ^{s} at the l node point of the j background element; G is a gradient of the periodic distribution; g̅ is a designated gradient constraint value; v_{b} is the volume of the background elements; N_{b} is the number of the total fine elements in a solution domain; ∥∇tₗ∥ is a value of the periodic distribution gradient ∥∇t(r)∥ at the l node point of the j background element; and H_{η}(x) is a regularization Heaviside function.

### (III) Optimization Solution

Based on the above constructed optimization problem, only two unknown parameters t(r) and c(r) need to be calculated and optimized. Topological optimization is regarded as rough optimization; after the topology of the whole porous structure is determined, more detailed optimization, i.e., geometric optimization, is conducted; therefore, at fixed thickness, t(r) is optimized firstly, then a topological parameter is fixed, and c(r) is optimized. A specific optimization process is as follows:

Step 1: topological optimization: interpolating the topological parameter t(r) by a radial basis function (RBF) interpolation method and converting function optimization into the optimization of the parameter at an interpolation node point; randomly selecting an interpolation point {pᵢ}ᵢ₌₁ⁿ^{ᵣ}∈Ω_{M} in the design domain Ω_{M}, so that the form of interpolation t(r) is:

$$t ( r ) = {\sum }_{i = 1}^{{n}_{r}} {R}_{i} ( r ) {a}_{i}^{t} + {\sum }_{j = 1}^{m} {q}_{j} ( r ) {b}_{j}^{t}$$

wherein Rᵢ(r)=R(∥r−pᵢ∥); logarithmic RBF R(x)=x² log(|x|) is selected; {qⱼ(r)} is a polynomial for coordinates; and aᵢ^{t} and bⱼ^{t} are undetermined coefficients. Through derivation, (16) can be simplified as:

$$t ( r ) = {\sum }_{i = 1}^{{n}_{r}} {S}_{i} ( r ) {t}_{i}$$

wherein tᵢ=t(pᵢ) is a periodic value at a control point pᵢ; Sᵢ(r) is a polynomial form derived from matritization; thus, the optimization of a topological structure is converted into the optimization of the parameter {tᵢ}ᵢ₌₁ⁿ^{ᵣ};

finally, calculating the derivatives of an objective function and a constraint function for optimization variables as follows:

$$\frac{\partial I}{\partial {t}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {t}_{i}} ) {K}^{0} ) {U}_{k} \\ \frac{\partial V}{\partial {t}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b}$$

$$\frac{\partial G}{\partial {t}_{i}} = \frac{1}{‖ {Ω}_{M} ‖} {\sum }_{j = 1}^{{N}_{b}} {\sum }_{l = 1}^{8} {ℏ}^{′} ( \frac{‖ ∇ {t}_{l} ‖}{\overline{g}} ) \frac{\partial ‖ ∇ t ‖}{\partial t} {v}_{b}$$

wherein Nₛ is the number of the super elements; N_{b} is the number of the total background elements in the design domain; Uₖ is a node point displacement vector corresponding to the k element; K⁰=E₀B^{T}D⁰Bv_{b}; E₀ is Young's modulus; B is a strain matrix; D⁰ is a constitutive matrix of solid material filled by the elements; ϕₗ^{ij} is a value of ϕ^{s} at the l node point of the j background element in the i super element; then, sensitivity information is substituted into a solution optimization algorithm MMA which is commonly used in the field of mechanics to obtain the solution of the problem under topological optimization, i.e., the value of an optimal parameter {tᵢ}ᵢ₌₁ⁿ^{ᵣ}; in this way, the topological form of the porous structure is determined.

Step 2: geometric optimization: geometric optimization is the optimization of the parameter c(r); converting the function optimization into the optimization of the parameter {cᵢ}ᵢ₌₁ⁿ^{ᵣ} at the control point using the same technology as topological optimization by the RBF; randomly selecting an interpolation point {pᵢ}ᵢ₌₁ⁿ^{ᵣ}∈Ω_{M}, in the design domain Q_{M}, so that the form of interpolation c(r) is:

$$c ( r ) = {\sum }_{l = 1}^{{n}_{r}} {R}_{i} ( r ) {a}_{i}^{c} + {\sum }_{j = 1}^{m} {q}_{j} ( r ) {b}_{j}^{c}$$

wherein aᵢ^{c} and bⱼ^{c} are undetermined coefficients, which can also be simplified as:

$$c ( r ) = {\sum }_{i = 1}^{{n}_{r}} {S}_{i} ( r ) {c}_{i}$$

wherein cᵢ=c(pᵢ) is a thickness value at the control point pᵢ; Sᵢ(r) is a polynomial form derived from matritization; then, the sensitivity information about the optimization variables can be calculated and substituted into the MMA to obtain the solution of the problem under geometric optimization.

$$\frac{\partial l}{\partial {c}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {c}_{i}} ) {K}^{0} ) {U}_{k}$$

$$\frac{\partial V}{\partial {c}_{i}} = \frac{1}{8} {\sum }_{j = 1}^{{N}_{b}} {\sum }_{l = 1}^{8} \frac{\partial {H}_{η} ( {ϕ}_{l}^{kj} )}{\partial {c}_{i}} {v}_{b}$$

In this way, after topological optimization, controlling the thickness more precisely to minimize the structural energy, thereby having high hardness and strength.

The present invention conducts experiments on many different 3D models and uses different types of TPMS to design the porous structures. The experimental results can obtain the optimization model with high strength under the constrained volume. The porous structure obtained by the experiments is observed. It can be found that under the stress, the area with large stress in the model has small pore size and large thickness; and the mass is concentrated in this area. In contrast, the area with small stress has large pore size and small thickness. Under the gradient constraint, the transition between pores of different sizes is natural, and no stress concentration part is generated. To describe high efficiency of the present invention, the time complexity of the algorithm is compared with the general mechanical analysis software ANSYS. Through comparison, it is found that the time for calculating a force analysis process in the optimization process in the present invention is several tenths of or even a few hundredths of the time of ANSYS, which fully demonstrates the high efficiency of the present invention. At the same time, the results of mechanical analysis are also compared with ANSYS in accuracy. The experiment can show that the present invention can also meet the manufacturing requirements in the calculation accuracy.

1. An efficient method for representation and optimization of porous structures, comprising the following steps:
(I) multi-scale porous shell structure
firstly, establishing a multi-scale porous surface:
\tilde{φ}_{P}(r)=cos(2π·t(r)·x)+cos(2π·t(r)·y)+cos(2π·t(r)·z) (1)
wherein r=(x, y, z)∈R³ is a point in a space, and t(r)>0 is a continuous periodic distribution function, which controls a continuous change of a hole size;
then, constructing a multi-scale porous shell structure with thickness: using a closed region determined by two different isosurfaces with a same periodic distribution as an inner space of a porous shell, defining:
$${ϕ}^{s} ( r ) = min ( {ϕ}_{1} ( r ) , {ϕ}_{2} ( r ) ) \\ {ϕ}_{1} ( r ) = \tilde{φ} ( r ) + \tilde{c} ( r ) \\ {ϕ}_{2} ( r ) = \tilde{c} ( r ) - \tilde{φ} ( r ) \\ \tilde{c} ( r ) = {c}_{0} ( r ) \frac{t ( r )}{{t}_{0} ( r )} \qquad ( 2 )$$
wherein ϕ^{s}(r)>0 represents a region defined as Ωₛ, Ωₛ is an interior of the porous shell structure based on a triply periodic minimal surface; \tilde{φ}(r) is a multi-scale triply periodic minimal surface; and c₀(r) and t₀(r) are initial thickness and period value;
for a given model M, representing a model filled with the porous structure by a function:
ϕ^{M}=ϕ^{s}∩ϕ^{VDF}=min(ϕ^{s},ϕ^{VDF}) (3)
wherein ϕ^{VDF} is a distance field of the model M; and then ϕ^{M}≥0 represents the interior of the model filled with the porous structure;
(II) establishing an optimization model and discretization thereof
constructing a problem model, filling an inner space of the problem model using the constructed multi-scale porous shell structure by taking structural energy minimization as a goal and taking a model volume and a hole size distribution gradient as constraints, so that strength and stiffness of the problem model are still strong under a condition of given material volume constraints; calculating the problem model by a finite element analysis method and discretizing a problem; increasing calculation efficiency while ensuring calculation accuracy by a element method; uniformly dividing a design domain into elements firstly and then uniformly subdividing the elements into sub-divide elements; interpolating a displacement vector by a element mesh system; and describing the model by a sub-divide element system;
discretizing a problem in the problem model as follows:
$${min}_{c ( r ) , t ( r )} I = {F}^{T} U \qquad ( 6 )$$
so that
$$KU = F \\ V = \frac{1}{8} {\sum }_{j = 1}^{{N}_{b}} {\sum }_{l = 1}^{8} {H}_{η} ( {ϕ}_{l}^{j} ) {v}_{b} \leq \overline{V} \\ G = \frac{1}{‖ {Ω}_{M} ‖} {\sum }_{j = 1}^{{N}_{b}} {\sum }_{l = 1}^{8} ℏ ( \frac{‖ ∇ {t}_{l} ‖}{\overline{g}} ) {v}_{b} \leq 1 \qquad ( 7 )$$
wherein I is structural energy of the model; U is a displacement vector; F is a force vector of a node point; K is a total stiffness matrix; V is a volume fraction; V̅ is a designated volume constraint; ϕₗ^{j} is a value of ϕ^{s} at a l node point of a j sub-divide element; G is a gradient of the periodic distribution; g̅ is a designated gradient constraint value; v_{b} is the volume of the sub-divide elements; N_{b} is the number of the total sub-divide elements in a solution domain; ∥∇tₗ∥ is a value of the periodic distribution gradient ∥∇t(r)∥ at the l node point of the j sub-divide element; ∥Ω_{M}∥ is the volume of the design domain; and H_{η}(X) is a regularization Heaviside function, and h(x) is defined as follows:
$$ℏ ( x ) = \{ \begin{matrix}{( x - 1 )}^{2} + 1 , & if x \geq 1 \\ 1 , & if x < 1\end{matrix} \qquad ( 8 )$$
(III) optimization solution
based on the problem model, only two unknown parameters t(r) and c(r) need to be calculated and optimized; therefore, at fixed thickness, t(r) is optimized firstly, then a topological parameter is fixed, and c(r) is optimized; a specific optimization process is as follows:
step 1. topological optimization: interpolating the topological parameter t(r) by a radial basis function (RBF) interpolation method and converting function optimization into the optimization of the parameter at an interpolation node point; randomly selecting an interpolation point {pᵢ}ᵢ₌₁ⁿ^{ᵣ}∈Ω_{M} in the design domain Ω_{M}, so that the form of interpolation t(r) is:
$$t ( r ) = {\sum }_{i = 1}^{n ,} R ( r ) {a}_{i}^{t} + {\sum }_{j = 1}^{m} {q}_{j} ( r ) {b}_{j}^{t} \qquad ( 9 )$$
wherein Rᵢ(r)=R(∥r−pᵢ∥); logarithmic RBF R(x)=x² log(|x|) is selected; {qⱼ(r)} is a polynomial for coordinates; aᵢ^{t} and bⱼ^{t} are undetermined coefficients; through derivation, (9) is simplified as:
$$t ( r ) = {\sum }_{i = 1}^{{n}_{r}} {S}_{i} ( r ) {t}_{i} \qquad ( 10 )$$
wherein tᵢ=t(pᵢ) is a periodic value at a control point pᵢ; Sᵢ(r) is a polynomial form derived from matritization; thus, the optimization of a topological structure is converted into the optimization of a parameter the {tᵢ}ᵢ₌₁ⁿ^{ᵣ}, the parameter {tᵢ}ᵢ₌₁ⁿ^{ᵣ} is the set of tᵢ=t(pᵢ);
finally, calculating the derivatives of an objective function and a constraint function for optimization variables as follows:
$$\frac{\partial I}{\partial {t}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {t}_{i}} ) {K}^{0} ) {U}_{k} \\ \frac{\partial V}{\partial {t}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b} \\ \frac{\partial G}{\partial {t}_{l}} = \frac{1}{‖ {Ω}_{M} ‖} {\sum }_{j = 1}^{{N}_{b}} {\sum }_{l = 1}^{8} {ℏ}^{′} ( \frac{‖ ∇ {t}_{l} ‖}{\overline{g}} ) \frac{\partial ‖ ∇ t ‖}{\partial t} {v}_{b} \qquad ( 11 )$$
wherein Nₛ is the number of the elements; N_{b} is the number of the sub-divide elements in the design domain; Uₖ is a node point displacement vector corresponding to a k element; K⁰=E₀B^{T}D⁰Bv_{b}; E₀ is Young's modulus; B is a strain matrix; D⁰ is a constitutive matrix of solid material filled by the elements; ϕₗ^{ij} is a value of ϕ^{s} at the/node point of the j sub-divide element in the i element; then, sensitivity information is substituted into a solution optimization algorithm MMA (Method of Moving Asymptotes) which is commonly used in the field of mechanics to obtain a solution of a problem under topological optimization, wherein, the value of an optimal parameter {tᵢ}ᵢ₌₁ⁿ^{ᵣ}; the topological form of the porous structure is determined;
step 2. geometric optimization: topological optimization is regarded as rough optimization: after topology of whole porous structure is determined, more detailed optimization, wherein, geometric optimization is conducted;
converting the function optimization into the optimization of a parameter {cᵢ}ᵢ₌₁ⁿ^{ᵣ} at the control point using the same method as topological optimization by the RBF, {cᵢ}ᵢ₌₁ⁿ^{ᵣ} is the set of cₗ=c(pₗ); randomly selecting an interpolation point {pᵢ}ᵢ₌₁ⁿ^{ᵣ}∈Q_{M} in the design domain λ_{M}, so that the form of interpolation c(r) is:
c(r)=Σᵢ₌₁^{m}^{ᵣ}Rᵢ(r)aᵢ^{c}+Σⱼ₌₁^{m}qⱼ(r)bⱼ^{c} (12)
wherein aᵢ^{c} and bⱼ^{c} are undetermined coefficients, which are also simplified as:
$$c ( r ) = {\sum }_{i = 1}^{{n}_{r}} {S}_{i} ( r ) {c}_{i} \qquad ( 13 )$$
herein cₗ=c(pᵢ) is a thickness value at the control point pᵢ; Sᵢ(r) is a polynomial form derived from matritization; then, the sensitivity information about the optimization variables is calculated and substituted into the MMA to obtain the solution of a problem under geometric optimization;
$$\frac{\partial l}{\partial {c}_{t}} = - {\sum }_{k = 1}^{{N}_{b}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {c}_{t}} ) {K}^{0} ) {U}_{k} \\ \frac{\partial V}{\partial {c}_{t}} = \frac{1}{8} {\sum }_{j = 1}^{{N}_{b}} {\sum }_{l = 1}^{8} \frac{\partial {H}_{η} ( {ϕ}_{l}^{j} )}{\partial {c}_{i}} {v}_{b} \qquad ( 14 )$$
